(19) United States
(12) Patent Application Publication
(10) Pub. No.: US 2024/0368405 A1
(43) Pub. Date: Nov. 7, 2024

(54) EPOXY FUNCTIONAL AND PHOSPHOLIPID CONTAINING ADHESION PROMOTERS AND WARM MIX ADDITIVES FOR ASPHALT APPLICATIONS

(71) Applicant: CARGILL, INCORPORATED, Wayzata, MN (US)

(72) Inventors: Sung AHN, St. Paul, MN (US); Cristian CALCANAS, Minneapolis, MN (US); Todd L. KURTH, Maple Grove, MN (US); Hassan Ali TABATABAEE, Plymouth, MN (US); Yijun ZHOU, Maple Grove, MN (US)

(73) Assignee: CARGILL, INCORPORATED, Wayzata, MN (US)

(21) Appl. No.: 18/558,210

(22) PCT Filed: May 2, 2022
(86) PCT No.: PCT/US2022/072046

§ 371 Date: Oct. 31, 2023

Related U.S. Application Data
(60) Provisional application No. 63/185,014, filed on May 6, 2021.

(51) Int. Cl. C08L 95/00; C08L 91/00

(52) U.S. Cl. CPC C08L 95/00; C08L 91/00; C08L 2555/64; C08L 2555/82

(57) ABSTRACT

The present technology provides an asphalt additive that includes a phospholipid material and an epoxidized renewable oil or fat, where the epoxidized renewable oil or fat has an oxirane content of about 1.0% to about 15.0%. The present technology also provides use of the asphalt additive in asphalt applications and methods of making thereof.

### CROSS-REFERENCE TO RELATED APPLICATIONS

This application claims the benefit of U.S. Provisional Patent Application No. 63/185,014, filed May 6, 2021, which is incorporated by reference herein in its entirety.

### TECHNICAL FIELD

The present technology relates to asphalt additives for use in asphalt applications. In particular, the present technology relates to asphalt additives that include epoxidized renewable oils or fats and phospholipid materials for use as a Warm Mix Asphalt additive or to improve antistrip properties, and methods of making and using thereof, in asphalt applications.

### SUMMARY

In one aspect, the present technology provides an asphalt additive that includes a phospholipid material and an epoxidized renewable oil or fat, where the epoxidized renewable oil or fat has an oxirane content of about 1.0% to about 15.0%.

In a aspect, the present technology provides use of the asphalt additive as described herein to reduce or prevent stripping in asphalt applications.

In another aspect, the present technology provides use of the asphalt additive as described herein as a compaction aid in asphalt applications.

In another aspect, the present technology provides use of the asphalt additive as described herein as an adhesion promoter in asphalt applications.

In yet another aspect, the present technology provides use of the asphalt additive as described herein as a warm mix asphalt additive or a hot mix asphalt additive in asphalt applications.

In another aspect, the present technology provides an asphalt binder that includes bitumen; and an asphalt additive as described herein.

In yet another aspect, the present technology provides an asphalt concrete that includes about 0.25 wt % to about 8.0 wt % of an asphalt binder (based on total weight of the asphalt concrete) as described herein and about 92.00 wt % to about 99.75 wt % of mineral aggregate (based on total weight of the asphalt concrete).

In another aspect, the present technology provides a process for preparing a stable asphalt additive blend as described herein. The method of preparing the stable asphalt additive blend includes:
combining a phospholipid material with an epoxidized renewable oil or fat having an oxirane content of about 1.0% to about 15.0%; and
mixing the phospholipid material and the epoxidized renewable oil or fat under high shear to obtain the asphalt additive blend.

In a aspect, the present technology provides a method for preparing an asphalt binder that includes combining bitumen with an asphalt additive as described heretofore. The method may include an asphalt additive blend prepared according to a method that includes combining the phospholipid material with the epoxidized renewable oil or fat having an oxirane content of about 1.0% to about 15.0%, and mixing the phospholipid material and the epoxidized renewable oil or fat under high shear to obtain the asphalt additive blend.

In another aspect, the present technology provides a method for reducing or preventing stripping, adhesion promotion, aiding compaction, and/or improving durability of an asphalt concrete that includes:
adding an asphalt additive as described herein to bitumen to obtain an asphalt binder, and combining the asphalt binder to mineral aggregates to obtain an asphalt concrete;
wherein the asphalt concrete includes about 0.25 wt % to about 8.0 wt % of the asphalt binder and about 92.00 wt % to about 99.75 wt % of the mineral aggregates.

### BRIEF DESCRIPTION OF THE DRAWINGS

FIG. 1 illustrates a viscosity vs temperature curve for 50 wt % soy lecithin/50 wt % epoxidized linseed oil (Example 2).

FIG. 2 illustrates a viscosity vs temperature curve for an exemplary asphalt additive blends that include a fatty acid material as described in Example 2.

FIG. 3 illustrates a graph of the Dongre Workability Test (DWT) as a function of temperature to evaluate the Warm Mix Asphalt (WMA) additive property for a 50 wt % soy lecithin/50 wt % epoxidized linseed oil asphalt additive in asphalt concrete (Example 6).

FIG. 4 illustrates the % coating retained on mineral aggregates over a span of four weeks of thermal aging at 150° C. for an asphalt concrete that includes a 50 wt % soy lecithin/50 wt % epoxidized linseed oil asphalt additive.

### DETAILED DESCRIPTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter. One aspect described in conjunction with a particular aspect is not necessarily limited to that aspect and can be practiced with any other aspect(s).

Throughout this document, particularly in terms of providing a written description, all values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. Any listed range can be easily recognized as sufficiently describing and enabling the same range being broken down into at least equal halves, thirds, quarters, fifths, tenths, etc. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

As used herein, the singular forms “a,” “an,” and “the” and similar referents in the context of describing the elements (especially in the context of the following claims) include plural referents unless the context clearly dictates otherwise. For example, reference to “a substituent” encompasses a single substituent as well as two or more substituents, and the like. It is understood that any term in the singular may include its plural counterpart and vice versa, unless otherwise indicated herein or clearly contradicted by context.

In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. In the event of inconsistent usages between this document and those documents so incorporated by reference, the usage in the incorporated reference should be considered supplementary to that of this document; for irreconcilable inconsistencies, the usage in this document controls.

As used herein, the terms “for example,” “for instance,” “such as,” or “including” are meant to introduce examples that further clarify more general subject matter. Unless otherwise specified, these examples are provided only as an aid for understanding the applications illustrated in the present disclosure and are not meant to be limiting in any fashion.

In the methods described herein, the acts can be carried out in a specific order as recited herein. Alternatively, in any aspect(s) disclosed herein, specific acts may be carried out any order without departing from the principles of the disclosure, except when a temporal or operational sequence is explicitly recited. Furthermore, specified acts can be carried out concurrently unless explicit claim language recites that they be carried out separately or the plain meaning of the claims would require it. For example, a claimed act of doing X and a claimed act of doing Y can be conducted simultaneously within a single operation, and the resulting process will fall within the literal scope of the claimed process.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The term “substantially” as used herein refers to a majority of, or mostly, as in at least about 85%.

As used herein, the following terms have the following meanings unless expressly stated to the contrary.

The term “renewable oil or fat” as used herein refers to an oil or fat obtained from plant, animal, or microbial sources. The term “renewable oil or fat” includes renewable oil and fat derivatives unless otherwise indicated. Typically, renewable oils or fats are triacylglycerides. Examples of renewable oils include, but are not limited to, vegetable oils, algae oils, animal fats, tall oils, derivatives of these oils, combinations of any of these oils, and the like. Representative non-limiting examples of vegetable oils include canola oil, rapeseed oil, coconut oil, corn oil, cottonseed oil, olive oil, palm oil, peanut oil, safflower oil, sesame oil, soybean oil, sunflower oil, linseed oil, palm kernel oil, tung oil, jatropha oil, mustard oil, camelina oil, pennycress oil, hemp oil, algal oil, jojoba oil, and castor oil. Representative non-limiting examples of animal sources include animal fats such as lard, tallow, poultry fat, yellow grease, and fish oil. Tall oils are by-products of wood pulp manufacture. As used herein, “vegetable oils” refers to oils derived from vegetables and/or oil seeds. Typically, the renewable oil or fat may be refined, bleached, and/or deodorized. The renewable oil or fat may be present individually or as mixtures thereof. The renewable oil or fat may be modified; for example, the renewable oil or fat may be an epoxidized, hydrogenated, and/or fractionated renewable oil or fat.

The term “epoxidized” or “oxirane” refers to the presence of an epoxide (or epoxy) ring as shown below:

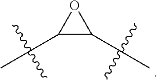 [SMILES: *C1OC1*]

The term “epoxidized renewable oil or fat” refers to a renewable oil or fat as described herein having the presence of an epoxide ring functionality along the fatty acid hydrocarbon chain. Typically, the epoxidized renewable oils or fats as described herein can be obtained by modifying renewable oils or fats with a high content of unsaturated fatty acids or fatty acid derivatives (i.e., polyunsaturated fatty acids (PUFA), monounsaturated fatty acids (MUFA), and the like). Exemplary renewable oils or fats with high PUFA and/or MUFA content may include, but are not limited to, soybean oil and linseed oil. For example, renewable oils and fats may be epoxidized by treatment with peracid. To increase the epoxide content such that the renewable oil or fat has a high concentration of di- and tri-epoxy fatty acid chains, the renewable oil or fat may be epoxidized and fractionated.

The term “oxirane content” or “epoxy oxirane content” (EOC) refers to the ratio of the sum of the total oxirane functionality molecular weight in a molecule to the total molecular weight and is represented as the percent (%) EOC.

An “acylglyceride” refers to a molecule having at least one glycerol moiety with at least one fatty acid residue that is linked via an ester bond. For example, acylglycerides can include monoacylglycerides, diacylglycerides, and triacylglycerides. The group acylglycerides can be further refined by additional descriptive terms and can be modified to expressly exclude or include certain subsets of acylglycerides.

A “monoacylglyceride” refers to a molecule having a glycerol moiety with a single fatty acid residue that is linked via an ester bond. The terms “monoacylglycerol,” “monoacylglyceride,” “monoglyceride,” and “MAG” are used interchangeably herein. Monoacylglycerides include 2-acylglycerides and 1-acylglycerides.

A “diacylglyceride” refers to a molecule having a glycerol moiety having two fatty acid residues linked via ester bonds. The terms “diacylglycerol,” “diacylglyceride,” “diglyceride,” and “DAG” are used interchangeably herein. Diacylglycerides include 1,2-diacylglycerides and 1,3-diacylglycerides.

A “triacylglyceride” refers to a molecule having a glycerol moiety that is linked to three fatty acid residues via ester bonds. The terms “triacylglycerol,” “triacylglyceride,” “triglyceride,” and “TAG” are used interchangeably herein.

The term “fatty acid” as used herein can refer to a molecule comprising a hydrocarbon chain and a terminal carboxylic acid group. As used herein, the carboxylic acid group of the fatty acid may be modified or esterified, for example as occurs when the fatty acid is incorporated into a glyceride or another molecule (e.g., COOR, where R refers to, for example, a carbon atom). Alternatively, the carboxylic acid group may be in the free fatty acid or salt form (i.e., COO″ or COOH). The ‘tail’ or hydrocarbon chain of a fatty acid may also be referred to as a fatty acid chain, fatty acid sidechain, or fatty chain. The hydrocarbon chain of a fatty acid will typically be a saturated or unsaturated aliphatic group. A fatty acid having N number of carbons, will typically have a fatty acid side chain having N−1 carbons. However, the subject application also relates to modified forms of fatty acids, e.g., epoxidized fatty acids, and thus the term fatty acid may be used in a context in which the fatty acid has been substituted or otherwise modified as described.

A “fatty acid residue” is a fatty acid in its acyl or esterified form.

A “saturated” fatty acid is a fatty acid that does not contain any carbon-carbon double bonds in the hydrocarbon chain. An “unsaturated” fatty acid contains one or more carbon-carbon double bonds. A “polyunsaturated” fatty acid contains more than one such carbon-carbon double bond while a “monounsaturated” fatty acid contains only one carbon-carbon double bond. Carbon-carbon double bonds may be in one of two stereoconfigurations denoted cis and trans. Naturally occurring unsaturated fatty acids are generally in the “cis” form. Epoxidized renewable oil or fat may include one or more epoxide rings formed from cis or trans carbon-carbon double bonds.

Non-limiting examples of fatty acids include C8, C10, C12, C14, C16 (e.g., C16:0, C16:1), C18 (e.g., C18:0, C18:1, C18:2, C18:3, C18:4), C20 and C22 fatty acids. For example, the fatty acids can be caprylic (8:0), capric (10:0), lauric (12:0), myristic (14:0), palmitic (16:0), stearic (18:0), oleic (18:1), linoleic (18:2) and linolenic (18:3) acids.

The fatty acid composition of an oil can be determined by methods well known in the art. The American Oil Chemist's Society (AOCS) maintains analytical methods for a wide variety of tests performed on vegetable oils. Hydrolysis of the oil's components to produce free fatty acids, conversion of the free fatty acids to methyl esters, and analysis by gas-liquid chromatography (GLC) is the universally accepted standard method to determine the fatty acid composition of an oil sample. AOCS (2009) Ce 1-62 describes the procedure used.

The term “antistrip” or “antistripping” refers to an additive that improves the adhesion between the asphalt binder and mineral aggregates. The use of antistripping additives results in a more durable bond between the asphalt binder and the mineral aggregate when in the presence of moisture, making the combination more resistant to “stripping” or loss of asphalt coating on the mineral aggregate.

The term “iodine value” (commonly abbreviated as IV) as used herein is the mass of iodine in grams that is consumed by 100 grams of a chemical substance. Iodine numbers are often used to determine the amount of unsaturation in fats, oils, and waxes. In fatty acids, unsaturation occurs mainly as double bonds which are very reactive towards halogens, iodine in this case. Thus, the higher the iodine value, the more unsaturation is present in the sample. The Iodine Value of a material can be determined by the standard well-known Wijs method (AOCS (1993) Cd 1-25).

Warm Mix Asphalt (WMA) additives are used to reduce the production and compaction temperatures for asphalt pavements. These additives often help improve the ability of the asphalt binder to coat the mineral aggregates in an asphalt mix and allow for easier compaction of the mix under a roller with lower mechanical or thermal energy requirement. Often it is desirable for such additives to also improve the adhesion between the asphalt and the aggregate and the ability of the coating to resist stripping off in the presence of moisture. The impact of a WMA additive can be demonstrated through its ability to modify the rate of compaction and density achievement of the asphalt mix. These additives are often blended into the bitumen as part of the asphalt binder.

Various theories have been proposed to describe the mechanisms of action of various WMA additives, including plasticizing the binder and reduction of the internal friction between aggregates, although the exact nature of the mechanism is difficult to conclusively determine. Therefore, the discussion of WMA properties is done without being bound to a specific mechanism theory.

The backbone of the durability and quality of asphalt concrete is the adhesion present at the interface between the bitumen and mineral aggregate. Adhesion between the bitumen and mineral aggregates can be weakened over time by many factors including repeated traffic loading, weather, and moisture damage which can manifest itself in various forms including fatigue cracking and distortions such as rutting of the pavement mixes. Moisture susceptibility of the pavement is one of the leading contributing factors of distress in asphalt concrete pavements. Moisture can instigate stripping by permeating into the pores of the mineral aggregates and displacing bitumen film from the mineral aggregate surface. Stripping due to loss of adhesion can eventually lead to premature failure of the pavement.

The present technology relates to asphalt additive that includes epoxidized renewable oil or fat and a phospholipid material, and methods of making and use thereof, which improves the overall performance properties when incorporated in asphalt applications.

### Asphalt Additive

In one aspect, the present technology provides an asphalt additive that includes a phospholipid material and an epoxidized renewable oil or fat, where the epoxidized renewable oil or fat has an oxirane content of about 1.0% to about 15.0%.

The asphalt additive may have a weight ratio of the phospholipid material to the epoxidized renewable of oil or fat of about 5:1 to about 1:5. For example, the weight ratio may be about 5:1 to about 1:5, about 3:1 to about 1:3, about 2:1 to about 1:2, or about 1:1 Suitable weight ratios may include about 5:1, about 4.5:1, about 4:1, about 3.5:1, about 3:1, about 2.5:1, about 2:1, about 1.5:1, about 1:1, about 1:1.5, about 1:2, about 1:2.5, about 1:3, about 1:3.5, about 1:4, about 1:4.5, about 1:5, or any range including and/or in between any two of the preceding values.

The asphalt additive of the present technology may include the phospholipid material in an amount of about 10.0 wt % to about 80.0 wt %. For example, the phospholipid material may be present in an amount about 10.0 wt % to about 80.0 wt %, about 10.0 wt % to about 60 wt. %, about 40.0 wt % to about 60.0 wt %, or about 45.0 wt % to about 55 wt %. The phospholipid material may be present in amounts of about 10.0 wt %, about 15.0 wt %, about 20.0 wt %, about 25.0 wt %, about 30 wt. %, about 35 wt %, about 40.0 wt %, about 45.0 wt %, about 50.0 wt %, about 55.0 wt %, about 60.0 wt %, about 65.0 wt %, about 70.0 wt %, about 75.0 wt %, about 80.0 wt %, or any range including and/or in between any two of the preceding values.

The term “phospholipid material” as used herein refers to a material containing phospholipids. Phospholipids are generally characterized as lipids having a glycerol or sphingosine backbone esterified to two fatty acids and phosphoric acid or a phosphoric acid ester. The phospholipids of the phospholipid material may further include phospholipid derivatives. For example, suitable phospholipid derivatives may include hydrolyzed phospholipids, acetylated phospholipids, epoxidized phospholipids, hydroxylated phospholipids, or mixtures thereof. Typically, the phospholipid material as described herein may include at least about 50 wt % to 100 wt % of phospholipids based on the total weight of the phospholipid material. For example, the phospholipid material may include at least about 50 wt % to 100 wt %, at least about 60 wt % to 100 wt %, at least about 70 wt % to 100 wt %, at least about 80 wt % to 100 wt %, at least about 90 wt % to 100 wt %.

The phospholipids may be natural phospholipids, synthetic phospholipids, or combinations thereof. As described herein, natural phospholipids may be phospholipids from plant, animal, or microbial sources. For example, phospholipids may include, but are not limited to, phosphatidyl choline, phosphatidyl inositol, phosphatidyl ethanolamine, phosphatidic acid, or combinations thereof.

The phospholipid material may include a lecithin material as the phospholipid source. The term “lecithin” or “lecithin material” as used herein refers to a complex mixture of acetone-insoluble phospholipids alone or together with a variety of other compounds, including but not limited to fatty acids, triglycerides, sterols, carbohydrates, glycolipids, and water. Phospholipid content in lecithin compositions is measured using acetone-insoluble testing methods as known to persons of ordinary skill in the art (such as AOCS (2017) Method Ja 4-46). Lecithin may be obtained from a variety of sources, including but not limited to plant sources (such as vegetable oils), animal sources (such as egg and bovine brain), or microbial sources. For example, suitable sources of lecithin may include, but are not limited to, soybean lecithin, rapeseed lecithin, sunflower-seed lecithin, egg lecithin, peanut lecithin, corn lecithin, bovine brain lecithin, jojoba lecithin, or mixtures thereof. With respect to the aforementioned lecithin sources, the phospholipid material may be obtained from crude refining streams containing fatty acids and phosphatidyl material, as described in U.S. Pat. No. 10,689,406, incorporated herein by reference in its entirety. Additionally or alternatively, the lecithin may be a modified lecithin. For example, the modified lecithin may include, but is not limited to, hydrogenated lecithin, epoxidized lecithin, de-oiled lecithin, or mixtures thereof.

The lecithin material may include about 5 wt % to 100 wt % of acetone-insoluble matter based on total weight of the lecithin material. Suitable amounts of acetone-insoluble material may include about 5 wt % to 100 wt %, about 5 wt % to about 75 wt %, about 30 wt % to about 70 wt %, or about 40 wt % to about 65 wt %. For example, the lecithin material may include acetone-insoluble matter amounts of about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, 100 wt %, or any range including and/or in between any two of the preceding values.

The asphalt additive may include about 10.0 wt % to about 80.0 wt % of the epoxidized renewable oil or fat based on total weight of the asphalt additive. For example, the epoxidized renewable oil or fat may be present in an amount about 10.0 wt % to about 80.0 wt. %, about 10.0 wt % to about 60.0 wt %, about 40.0 wt % to about 60.0 wt %, or about 45.0 wt % to about 55 wt %. Typically, the asphalt additive may include the epoxidized renewable oil or fat in amounts of about 10.0 wt %, about 15.0 wt %, about 20.0 wt %, about 25.0 wt %, about 30 wt. %, about 35 wt %, about 40.0 wt %, about 45.0 wt %, about 50.0 wt %, about 55.0 wt %, about 60.0 wt %, about 65.0 wt %, about 70.0 wt %, about 75.0 wt %, about 80.0 wt %, or any range including and/or in between any two of the preceding values.

The epoxidized renewable oil or fat may have an oxirane content of about 1.0% to about 15.0%, about 4.0% to about 12.0%, about 6.0% to about 10.0%, about 8.0% to about 10.0%, or any range including and/or in between any two of the preceding values. Suitable oxirane contents of the epoxidized renewable oil or fat may include about 1.0%, about 2.0%, about 3.0%, about 4.0%, about 5.0%, about 6.0%, about 7.0%, about 8.0%, about 9.0%, about 10.0%, about 11.0%, about 12.0%, about 13.0%, about 14.0%, about 15.0%, or any range including and/or in between any two of the preceding values.

The epoxidized renewable oil or fat includes epoxidized fatty acids or epoxidized fatty acid derivatives. For example, the epoxidized fatty acids or epoxidized fatty acid derivatives may include, but are not limited to, epoxidized vegetable oils, epoxidized acetylated-acylglycerides, epoxidized fatty acid esters, estolides, or combinations thereof.

The epoxidized renewable oil or fat may include epoxidized soybean oil, epoxidized canola oil, epoxidized linseed oil, epoxidized soy methyl ester, epoxidized linseed methyl ester, epoxidized tall oil fatty acid (TOFA), epoxidized acetylated-triacylglycerol, epoxidized acetylated-diacylglycerol, epoxidized acetylated-monoacylglycerol, epoxidized 2-ethylhexyl soyate, epoxidized 2-ethylhexyl TOFA, epoxidized isoamyl soyate, epoxidized isoamyl palm stearin, epoxidized isoamyl TOFA, epoxidized isoamyl soyate, epoxidized soy methyl ester acetic acid estolide, epoxidized jojoba oil, or mixtures thereof. Typically, the epoxidized renewable oil or fat may include epoxidized soy oil, epoxidized linseed oil, epoxidized canola oil, or mixtures thereof. For example, the epoxidized renewable oil or fat may be epoxidized soy oil. In another example, the epoxidized renewable oil or fat may be epoxidized linseed oil.

The epoxidized renewable oil or fat may undergo fractionation or be a fractionated epoxidized renewable oil or fat. As used herein, the term “fractionation” refers to the process of separating a renewable oil or fat into several fractions having different properties including hardness and melting point.

The asphalt additive as described herein may further include a fatty acid material, such as soybean oil, linseed oil, canola oil, or mixtures thereof. Typically, the asphalt additive may include about 0.1 wt % to about 40.0 wt % of the fatty acid material based on total weight of the asphalt additive. Suitable amounts of the fatty acid material may include about 0.1 wt %, about 1.0 wt %, about 5.0 wt %, about 10.0 wt %, about 15.0 wt %, about 20.0 wt %, about 25.0 wt %, about 30.0 wt %, about 35.0 wt %, about 40.0 wt %, or any range including and/or in between any two of the preceding claims. For example, the fatty acid material may be a fractionated fatty acid material.

The asphalt additive as described herein typically has a viscosity of about 20 cSt to about 10,000 cSt at 25° C.; for example, when the asphalt additive is pre-blended prior to use in asphalt applications. Suitable viscosities at 25° C. may include about 20 cSt, about 30 cSt, about 40 cSt, about 50 cSt, about 60 cSt, about 70 cSt, about 80 cSt, about 90 cSt, about 100 cSt, about 200 cSt, about 300 cSt, about 400 cSt, about 500 cSt, about 600 cSt, about 700 cSt, about 800 cSt, about 900 cSt, about 1,000 cSt, about 1,500 cSt, about 2,000 cSt, about 2,500 cSt, about 3,000 cSt, about 3,500 cSt, about 4,000 cSt, about 4,500 cSt, about 5,000 cSt, about 5,500 cSt, about 6,000 cSt, about 6,500 cSt, about 7,000 cSt, about 7,500 cSt, about 8,000 cSt, about 8,000 cSt, about 8,500 cSt, about 9,000 cSt, about 9,500 cSt, about 10,000 cSt, or any range including and/or in between any two of the preceding values.

The inventors discovered the asphalt additive according to the present technology unexpectedly improved one or more performance properties when incorporated into asphalt applications. For example, the asphalt additive as described herein exhibits surprising enhancement of the overall performance of an asphalt or asphalt concrete, including adhesion promotion, antistripping, warm mix asphalt additive, hot mix asphalt additive, compaction aid, and durability of asphalt mixes.

The asphalt additive as described herein typically exhibits enhanced adhesion promotion in asphalt applications.

The asphalt additive as described herein typically exhibits enhanced antistripping in asphalt applications.

The asphalt additive as described herein typically improve compaction in asphalt applications.

The asphalt additive as described herein typically improves durability of asphalt mixes in asphalt applications.

The asphalt additive as described herein typically is a warm mix asphalt additive.

Alternatively, the asphalt additive as described herein may be a hot mix asphalt additive.

In a aspect, the present technology provides use of the asphalt additive as described herein to reduce or prevent stripping in asphalt applications.

In another aspect, the present technology provides use of the asphalt additive as described herein as a compaction aid in asphalt applications.

In another aspect, the present technology provides use of the asphalt additive as described herein as an adhesion promoter in asphalt applications.

In yet another related aspect, the present technology provides use of the asphalt additive as described herein as a warm mix asphalt additive or a hot mix asphalt additive in asphalt applications. For example, the use of the asphalt additive is as a warm mix asphalt additive. In another example, the use of the asphalt additive is as a hot mix asphalt additive.

### Asphalt Binder

In another aspect, the present technology provides an asphalt binder that includes bitumen; and an asphalt additive as described herein. Generally, the asphalt additive of the present technology includes a phospholipid material and an epoxidized renewable oil or fat, where the epoxidized oil and fat has an oxirane content of about 1.0% to about 15.0%. For purposes of the present technology, the term “bitumen” or “asphalt” refers to the binder phase of asphalt concrete and is a class of black or dark-colored solid, semisolid, resinous or viscous cementitious substances-natural, recycled, or manufactured-composed principally of high molecular weight polar hydrocarbon species (e.g., asphaltenes), of which asphalts, tars, pitches, and asphaltites are typical. (Asphalt, Kirk-Othmer Encyclopedia of Chemical Technology, John Wiley & Sons Inc.)

The asphalt binder may include about 0.1 wt % to about 3.0 wt % of the asphalt additive as described herein based on total weight of the asphalt binder. For example, the asphalt additive may be present in the asphalt binder in amounts of about 0.1 wt % to about 3.0 wt %, about 0.1 wt % to about 2.0 wt %, about 0.1 wt % to about 1.5 wt %, about 0.3 wt % to about 1.0 wt %, or about 0.3 wt % to about 0.7 wt %. Suitable amounts of the asphalt additive may include about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, about 1.5 wt %, about 2.0 wt %, about 2.5 wt %, about 3.0 wt %, or any range including and/or in between any two of the preceding values.

The asphalt binder may include about 97.0 wt % to about 99.9 wt % of bitumen based on total weight of the asphalt binder. Suitable amounts of bitumen present in the asphalt binder may include about 97.0 wt %, about 97.5 wt %, about 98.0 wt %, about 98.5 wt %, about 99.0 wt %, about 99.1 wt %, about 99.2 wt %, about 99.3 wt %, about 99.4 wt %, about 99.5 wt %, about 99.6 wt %, about 99.7 wt %, about 99.8 wt %, about 99.9 wt %, or any range including and/or in between any two of the preceding values.

The asphalt binder as described herein may further include one or more additional additives suitable for asphalt applications. For example, the one or more additional additives may include, but are not limited to thermoplastic elastomeric and thermoplastic plastomeric polymers (such as styrene-butadiene-styrene, ethylene vinyl-acetate, functionalized polyolefins, or the like), polyphosphoric acid (PPA), antistripping additives (such as amine-based, phosphate-based, and the like), warm mix additives, emulsifiers, fibers, a polymerized oil (such as polymerized oils as described in U.S. Patent Publication No. 2018/0044525, incorporated herein by reference in its entirety), or mixtures thereof.

The asphalt binder as described herein may further include PPA. Typically, the asphalt binder may include about 0.1 wt % to about 5.0 wt % of PPA based on total weight of the asphalt binder. For example, the asphalt binder may include PPA in an amount of about 0.1 wt %, about 0.5 wt %, about 1.0 wt %, about 1.5 wt %, about 2.0 wt %, about 2.5 wt %, about 3.0 wt %, about 3.5 wt %, about 4.0 wt %, about 4.5 wt %, about 5.0 wt %, or any range including and/or in between any two of the preceding values.

### Asphalt Concrete

In yet another aspect, the present technology provides an asphalt concrete that includes about 0.25 wt % to about 8.0 wt % of an asphalt binder as described herein (based on total weight of the asphalt concrete) and about 92.00 wt % to about 99.75 wt % of mineral aggregate (based on total weight of the asphalt concrete). As described herein, the asphalt binder includes bitumen and an asphalt additive that includes a phospholipid material and an epoxidized renewable oil or fat having an oxirane content of about 1.0% to about 15.0% as described heretofore.

The asphalt concrete as described herein may include about 0.25 wt % to about 8.0 wt %, about 0.25 wt % to about 6.5 wt %, about 0.25 wt % to about 5.0 wt %, about 0.30 wt % to about 4.0 wt %, or about 0.5 wt % to about 3.5 wt % of the asphalt binder based on total weight of the asphalt. For example, the asphalt binder may be present in the asphalt concrete in amounts of about 0.25 wt %, about 0.30 wt %, about 0.40 wt %, about 0.50 wt %, about 0.60 wt %, about 0.70 wt %, about 0.80 wt %, about 0.90 wt %, about 1.0 wt %, about 1.5 wt %, about 2.0 wt %, about 2.5 wt %, about 3.0 wt %, about 3.5 wt %, about 4.0 wt %, about 4.5 wt %, about 5.0 wt %, about 5.5 wt %, about 6.0 wt %, about 6.5 wt %, about 7.0 wt %, about 7.5 wt %, about 8.0 wt %, or any range including and/or in between any two of the preceding values.

“Mineral aggregates” refers to the solid and generally inert load supporting components, including but not limited to clay, sand, gravel, crushed stone, slag, or rock dust, of asphalt concrete. The mineral aggregate may be further characterized by its calcium carbonate content. For purpose of the present technology, the calcium carbonate concentration of the mineral aggregates can be determined to classify the chemistry of the aggregates. The main component of limestone is calcium carbonate, which may be determined by back titration that includes adding an excess amount of acid to the unknown basic aggregates and then titrated back to the endpoint with a standardized NaOH. Typically, the mineral aggregates used in asphalt applications may be the result of one or more sources of aggregate as described herein (e.g., stone, rock, gravel, and the like), each of which may be further crushed, screened or graded to meet various mineral aggregate gradations. Mineral aggregate gradations used in asphalt applications are generally classified with terms such as “dense graded,” “gap graded,” “well graded,” and “poorly graded,” depending on the application. Mineral aggregate gradations in asphalt applications are typically defined by the largest sieve opening size that retains a portion of the gradation. For example, the largest size may include, but is not limited to, 1.5″, 1″, ¾″, and ½″ sieve sizes.

The asphalt concrete may include the mineral aggregates in amounts of about 92.00 wt %, about 92.50 wt %, about 93.00 wt %, about 93.50 wt %, about 94.00 wt %, about 94.50 wt %, about 95.00 wt %, about 95.50 wt %, about 96.00 wt %, about 96.50 wt %, about 97.00 wt %, about 97.50 wt %, about 98.0 wt %, about 98.5 wt %, about 99.0 wt %, about 99.25 wt %, about 99.50 wt %, about 99.75 wt %, or any range including and/or in between any two of the preceding values.

The asphalt concrete may further include recycled materials. For example, the recycled material may include recycled bituminous material, recycled aggregates, reclaimed asphalt pavement (RAP) millings, recycled asphalt shingles (RAS), or mixtures thereof.

### Methods

In another aspect, the present technology provides a process for preparing a stable asphalt additive blend. The method of preparing the stable asphalt additive blend includes: combining a phospholipid material with an epoxidized renewable oil or fat having an oxirane content of about 1.0% to about 15.0%; and
mixing the phospholipid material and the epoxidized renewable oil or fat under high shear to obtain the asphalt additive blend.

The inventors discovered that the inventive and scalable method for combining epoxidized renewable oils or fats with phospholipid materials produces a homogenous and storage-stable asphalt additive blend. The inventors observed a significant increase in viscosity and the formation of gelled products when mixing the epoxidized renewable oils and fats with phospholipid containing materials (such as lecithin) under low shear blending. Such epoxidized oil/phospholipid material blends were not storage stable and resulted in phase separation in a matter of days, which does not occur for blends using non-epoxidized vegetable oils. The inventors unexpectedly discovered that combining the epoxidized renewable oil or fat with phospholipid materials gradually and mixing under a high shearing energy, like that provided by a laboratory benchtop homogenizer or high shear mill (such as IKA Ultra Turrax T50 basic or Benedict 3450 rpm 2HP), results in a stable and lower viscosity asphalt additive blend without the formation of a visible gel phase or any apparent phase separation over time.

The resultant asphalt additive blend is in keeping with the asphalt additive as described herein. For example, the asphalt additive blend may include a weight ratio of the phospholipid material to the epoxidized renewable oil or fat of about 5:1 to about 1:5. The asphalt additive blend of the present technology may include the phospholipid material in an amount of about 10.0 wt % to about 80.0 wt % based on total weight of the asphalt additive blend. The asphalt additive blend as described herein may include about 10.0 wt % to about 80.0 wt % of the epoxidized renewable oil or fat based on total weight of the asphalt additive blend. The epoxidized renewable oil or fat may be a fractionated epoxidized renewable oil or fat.

The method may further include combining the phospholipid material and epoxidized renewable oil or fat with a fatty acid material as described herein. For example, the asphalt additive blend may include about 0.1 wt % to about 40.0 wt % of the fatty acid material based on total weight of the asphalt additive blend.

The asphalt additive blend as described herein may have a viscosity of about 20 cSt to about 10,000 cSt at 25° C.

In an aspect, the present technology provides a method for preparing an asphalt binder that includes combining bitumen with an asphalt additive as described herein. For example, the method may include an asphalt additive blend prepared according to a method that includes combining the phospholipid material with the epoxidized renewable oil or fat having an oxirane content of about 1.0% to about 15.0%, and mixing the phospholipid material and the epoxidized renewable oil or fat under high shear to obtain the asphalt additive blend.

In another aspect, the present technology provides a method for reducing or preventing stripping, promoting adhesion, aiding compaction, and/or improving durability of an asphalt concrete that includes:
adding an asphalt additive as described herein to bitumen to obtain an asphalt binder, and combining the asphalt binder to mineral aggregates to obtain an asphalt concrete;
wherein the asphalt concrete includes about 0.25 wt % to about 8.0 wt % of the asphalt binder and about 92.00 wt % to about 99.75 wt % of the mineral aggregates.

The present invention, thus generally described, will be understood more readily by reference to the following examples, which are provided by way of illustration and are not intended to be limiting of the present invention.

### EXAMPLES

### Example 1—Preparation of Epoxidized Vegetable Oils and Methyl Esters

Vegetable oil as described herein was epoxidized by peracid formed in situ by hydrogen peroxide and formic acid. The desired amount of vegetable oil and formic acid (0.5 mol to 1 mol double bond) were charged to a 4-neck round-bottom flask equipped with a thermocouple, nitrogen line, reflux condenser, addition funnel, and overhead agitator. The reactor is heated to 65° C. before hydrogen peroxide (35 v/v %, 1.8 mol peroxide per mol double bond) is added dropwise to the reaction via addition funnel over 2-3 h. After the addition is complete, the reaction continues until the iodine value reaches 0 g I₂/100 g or stabilizes. The product is then washed twice with water and dried under 20 torr vacuum at 65° C., which affords a pale to light yellow liquid.

### Example 2—General Preparation of Stable Epoxidized Linseed Oil and Soy Lecithin Blend (Warm Mix Additive Blend)

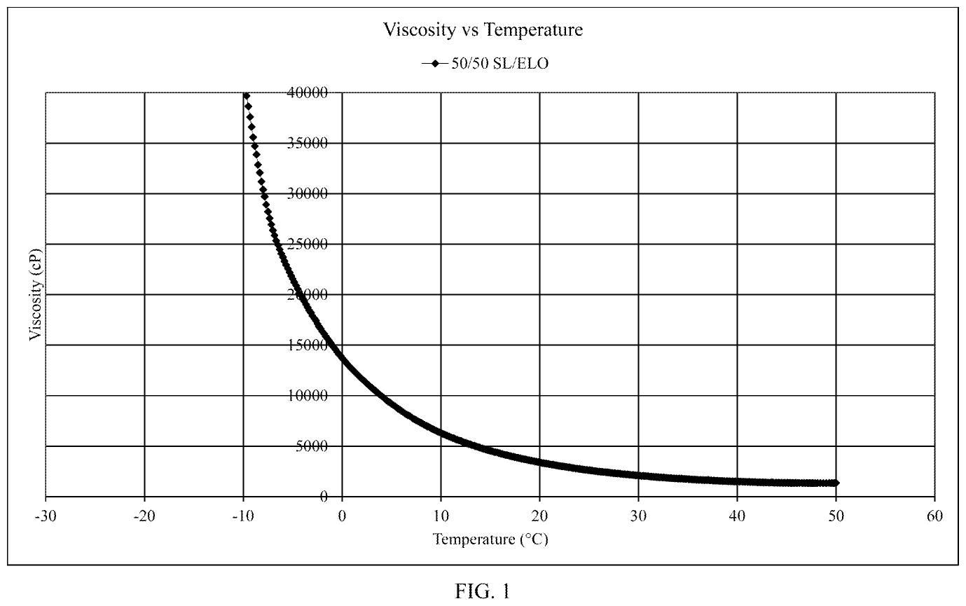

Amounts of soy lecithin (SL) were incorporated slowly to amounts of epoxidized linseed oil (ELO) having an oxirane content of 9.50% under high shear mixing conditions to obtain a 1:1 weight ratio additive. The viscosity of the SL/ELO additive blend over a range of temperatures was determined using a Dynamic Shear Rheometer (DSR). DSR measures and calculates different properties of asphalt binders, such as the viscoelastic behavior of the asphalt binders tested. A constant shear rate was applied to the sample as the temperature ramped down from 50° C. to −20° C. A 25 mm diameter size sample was made for testing. As shown in FIG. 1, the SL/ELO additive exhibits a viscosity of about 2500 cSt at 25° C.

Following the above procedure, SL/ELO additives were prepared that further incorporate epoxidized soy methyl ester (ESME) to obtain a SL:ELO:ESME additive having a weight ratio of 1:1:0.5.

### Viscosity Sweeps

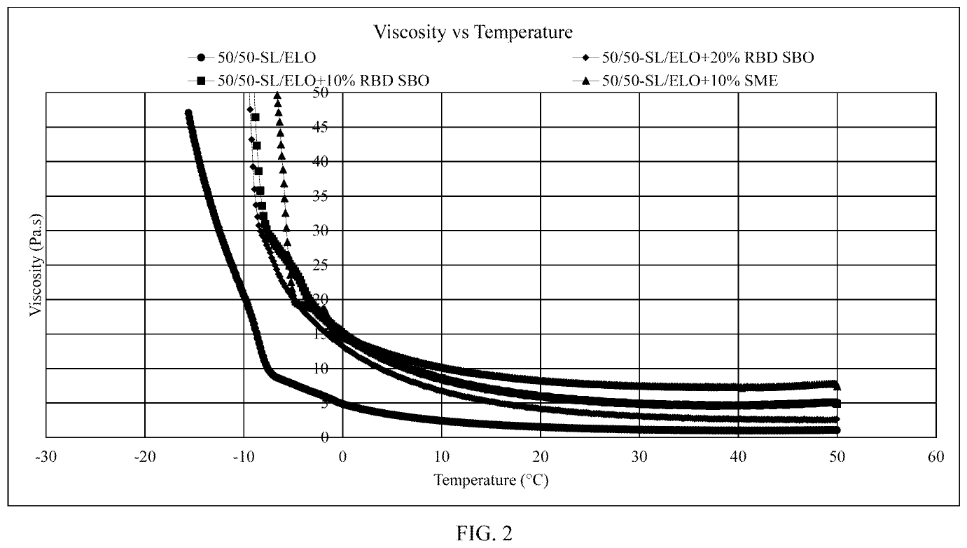

Viscosity measurements of the SL/ELO additive blend described above and various SL/ELO blends containing a third vegetable oil component were determined using DSR. A constant shear rate was applied to the sample as the temperature ramped down from 50° C. to −20° C. 25 mm diameter size samples were made for testing. As shown in FIG. 2, the SL/ELO additive blend exhibited a lower overall viscosity compared to additives with additional 10% soybean oil (SBO), 20% SBO, and soy methyl ester (SME). Thus, the measurements indicate the lecithin/epoxidized renewable oil or fat asphalt additive blends surprisingly exhibit improved lower viscosity over additives having a mixture of epoxidized renewable oil or fat and non-epoxidized renewable oil or fat.

### Example 3—Evaluation of Synergistic Adhesion Promotion Properties Using Tensile Strength Ratio (TSR) Test

In this example, the synergistic effect of the 50/50 SL/ELO additive blend of Example 2 was evaluated via the TSR test (ASTM D4867-09 (2014)) for a hot mix asphalt made using Dolomitic Limestone aggregate. The TSR measurement assesses the structural integrity of the asphalt mix. TSR values are the ratio between the Indirect Tensile Strength (psi) of a sample asphalt mix after a moisture regimen to that of the unconditioned dry asphalt mix: TSR (%)=(Indirect Tensile Strength of test sample÷Indirect Tensile Strength of unconditioned dry asphalt mix)*100. The TSR value is a measure of the resistance of the compacted samples to moisture-induced damage as determined by ASTM D4867-09 (2014).

The indirect tensile strength (psi) is a measure of the amount of compressive force (or max load) a material can withstand before failure. Indirect tensile strength is calculated as the max load (e.g., lbs) divided by the cross-sectional area (e.g., mm²) of the test sample. To obtain indirect tensile strength values for each test sample of asphalt, compacted samples (test samples and unconditioned dry asphalt mix samples) were prepared and subjected to compressive force exerted by bearing plates of the indirect tensile strength instrument, where the max load is recorded preceding failure (i.e., cracking) of the test sample. The max load is directly proportional to the tensile strength, which is a measure of the strength of adhesion between the asphalt binder and aggregate in the test sample. A higher tensile strength indicates stronger rigidity of the test sample.

A higher TSR indicates a lower moisture damage impact in a given mix. In this example, the SL-based composition contains 70 wt % SL that is blended with 30 wt % of a vegetable oil plasticizer to reduce the viscosity of the SL. As shown in Table 1 below, the SL and ELO blend demonstrated a greater TSR improvement over the control (no additive) and SL based asphalt mixes or the predicted linear average of the ELO and SL based additives' individual performance, indicating the synergistic impact of blending the aforementioned components.

Table 1 shows that for the Dolomite aggregate the SL-based additive provided no improvement in TSR, while the ELO showed significant improvement. Most interestingly, the 50:50 blend of ELO and SL provided similar impressive improvement over the control. It can be clearly seen that combining ELO with SL did not result in any loss in performance, even though SL itself had not provided any improvement. This is a clear example of the synergistic performance of an epoxidized oil and a phospholipid containing material. A similar trend can be seen for the Granite #1 aggregate as well, in which the SL additive provided a lower impact on TSR value, while the combination of ELO and SL performed at statistically similar levels to that of the ELO itself.

TABLE 1
TSR Values from TSR test (Ex. 3)

| | *TSR (%) | | | |
|---|---|---|---|---|
| | Control | SL- | | |
| Mix Description | (No additive) | based | ELO | ELO/SL |
| Dolomite Agg, 5.6% PG64-22 | 66% | 66% | 85% | 88% |
| Granite #1 Agg, 5.2% PG64-22 | 53% | 87% | 99% | 96% |

*TSR (%) = (Indirect Tensile Strength of test sample ÷ Indirect Tensile Strength of unconditioned dry asphalt mix)*100

### Example 4—Evaluation of Synergistic Adhesion Promotion Properties Using the Asphalt Boiling Test

In this example, the synergistic effect of the 50/50 SL/ELO additive blend of Example 2 was compared to the individual use of the SL-based additive of Example 3, and ELO, using the asphalt boiling test as described by the VTM-13 standard procedure of the Virginia Department of Transportation. A quartzite aggregate was coated with a PG64-22 asphalt binder containing 0.5% of each additive by weight of the asphalt binder. The results shown in Table 2 indicate the percent of the remaining binder coating the aggregates after being subjected to boiling, with a higher coating being desirable. As shown in Table 2, the results that the synergistic impact of the combination of the SL and ELO components resulted in a performance exceeding that of the linear average of individual components, demonstrated the same synergy as shown in previous examples.

TABLE 2
TSR Values from TSR test (Ex. 4)

| | 0.5% | 0.5% | 0.5% |
|---|---|---|---|
| Mix Description | SL-based | ELO | ELO/SL |
| Quartzite Agg, PG64-22 | 88% | 100% | 99% |

### Example 5—Evaluation of Synergistic Antistripping Properties Exhibited by Lecithin/Epoxidized Renewable Oil Blend in Asphalt Applications

The present technology exhibits an unexpectedly synergistic improvement in adhesion in asphalt paving applications. Antistripping was evaluated using the Shaker Table Stripping Test. In addition to the aforementioned TSR and boiling tests, the antistripping performance of the additives was further evaluated using the Shaker Table Stripping Test. This test is used to evaluate the affinity between the aggregates and bitumen after conditioning the bitumen-covered aggregates in water at 60° C. with orbital agitation of variable speed for a period of time. The test method was adapted based on the Quebec DOT method (“The Evaluation of Binder Resistance to Stripping for a Given Aggregate Surface.” Quebec Department of Transportation, 2002.) In all the examples, the method was adapted to have an agitation speed of 200 rpm, a test temperature of 60° C., and a test time of 24 h were used for 75 gram asphalt mix samples, prepared as described in each example. Suitable orbital agitation speeds may be from 1 to 300 rpm, for example, from 100 to 200 rpm. Suitable test times can be from 1 to 48 h, for example, from 6 to 24 h. The agitation of the mix simulates potential moisture damage in pavement mixtures and accounts for displacement mechanism and stripping potential of the bitumen covered aggregates by water. The percentage of the bitumen coating retained on the aggregates is then visually evaluated by quantifying the bitumen covered rocks by which 90% coated is deemed pass as opposed to the uncoated rocks.

In the present example, mineral aggregates used were graded to all be at a size of 4.75 mm to 9.5 mm. The aggregates were washed on a sieve under running tap water to remove any debris and dusts that may interfere with coverage surface area of the aggregates, and subsequently dried in a force draft oven at 100° C. These processes were followed to reduce the variability in the test results which were noted on the Quebec DOT method. This procedure is an improvement of the incumbent Quebec DOT stripping test. The asphalt binder prepared included 99.5 wt % of bitumen and 0.5 wt % of the SL/ELO warm mix additive of Example 2. The blend was prepared by heating the bitumen to 150° C. in a force draft oven, adding room temperature SL/ELO additive at proper weight, and blending using a metal spatula for 30 s. 3.2 wt % of the asphalt binder by weight of the aggregates were further combined and blended with the mineral aggregates for 2 min. The dosage level of the additive may depend on the mineralogy of the aggregates such as surface chemistry and gradation of the aggregates. The asphalt binder-aggregate mix was then placed in the 150° C. force draft oven to ensure uniform coating of the aggregates. The sequence was repeated 4 to 5 times until the mix was uniformly dispersed. The finished blend was subsequently transferred, spread evenly onto the even surface, and allowed to cure for 24 h. Approximately 75 g of the material and 100 g of water were transferred into a 120 mL bottle and was placed in the orbital shaker table to assess the stripping potential of the asphalt mix.

PG 64-22 asphalt mixes modified with the warm mix additive blend of 50 wt % SL and 50 wt % ELO (50/50 SL/ELO) of Example 2. Two types of aggregates were used: limestone, consisting of nearly 90% of CaCO₃ (Agg “A”), and the other aggregates containing 53.97% of CaCO₃ (Agg “B”). As shown in Table 3, for both aggregates the 50/50 SL/ELO additive exhibited a greater antistripping performance than the linear average of the individual performance of SL and ELO as additives. Accordingly, the lecithin/epoxidized renewable oil or fat of the present technology exhibits a synergistic enhancement in antistripping properties in asphalt compared to epoxidized renewable oil or fats alone or lecithin alone.

TABLE 3
Improvement of coating compared to the control
mix (no additive). A higher value is desirable

| | | | Improvement in |
|---|---|---|---|
| | | % bitumen | aggregate coated |
| Asphalt | | coating remaining | compared to |
| additive | Mix description | on aggregates, % | control, % |
| Control | Agg A, PG64-22 | 34.94 | 0.00 |
| 0.5% SL | Agg A, PG64-22 | 43.76 | 8.82 |
| 0.5% ELO | Agg A, PG64-22 | 62.43 | 27.49 |
| 0.5% ELO/SL | Agg A, PG64-22 | 68.43 | 33.49 |
| Control | Agg B, PG64-22 | 24.42 | 0.00 |
| 0.5% SL | Agg B, PG64-22 | 62.34 | 37.92 |
| 0.5% ELO | Agg B, PG64-22 | 84.22 | 59.80 |
| 0.5% ELO/SL | Agg B, PG64-22 | 80.75 | 56.33 |

### Example 6—Evaluation of Warm Mix Properties

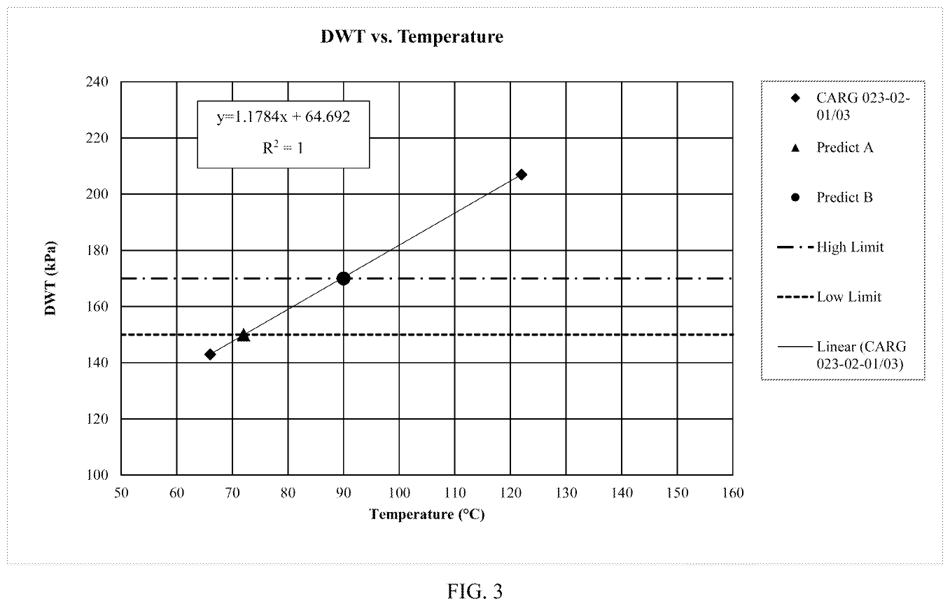

The use of laboratory methods to measure the ability of warm mix additives to reduce production temperature has typically been difficult due to the high efficiency of lab compactors to achieve density targets. However, recently the Dongre Workability Test (DWT) was developed to aid in capturing such trends in the lab. In the present example, the DWT was performed with Lithonia Granite and 0.5 wt % dosage of the SL/ELO additive in the asphalt binder, which advantageously provided both anti-stripping and WMA properties. As shown in Table 1 and FIG. 3, the SL and ELO blend demonstrated a reduction of 2.4° C. in the Finish Roller temperature and a reduction of 7.3° C. in the Breakdown Roller temperature. Table 4 shows the SL/ELO additive in the asphalt binder improves (i.e., lowers) the compaction temperature compared to the control (no additive). The DWT temperatures are considered to be directionally indicative of the expected trends for compaction of actual magnitude of the possible temperature reduction may be different, and most likely much larger, in the field. Thus, the results show that the asphalt additive containing the epoxidized renewable oil or fat and phospholipid material exhibits WMA properties and aids compaction.

TABLE 4
Predicted Compaction Temperature Reduction

| | | Predicted Compaction | | Predicted Temp. | |
|---|---|---|---|---|---|
| | | Temp., ° C. | | Reduction, ° C. | |
| | | Finish | Breakdown | Finish | Breakdown |
| | | Roller | Roller | Roller | Roller |
| Sample ID | Additive | Temp. | Temp. | Temp. | Temp. |
| PG 64-22 | — | 74.8 | 96.7 | | |
| (control) | | | | | |
| PG64-22 + | 50/50 | 72.4 | 89.4 | −2.4 | −7.3 |
| SL/ELO | SL/ELO | | | | |
| (0.5 wt %) | | | | | |

### Example 7—Storage Stability of Asphalt Modified with SL/ELO Additive

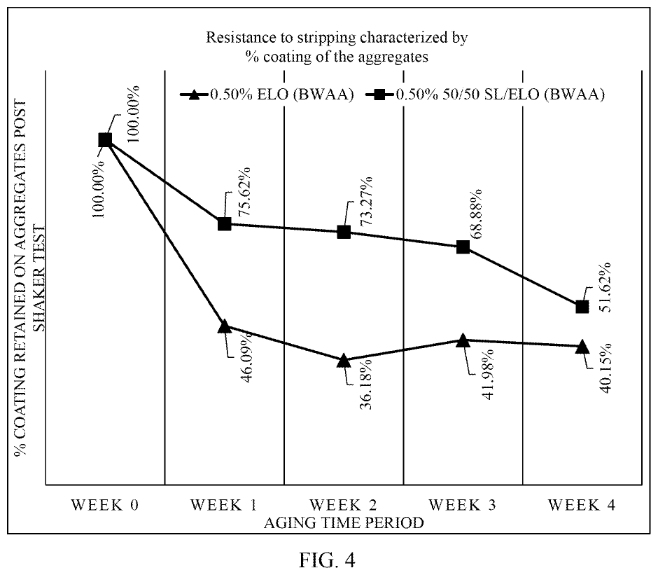

Thermal aging study was performed at 150° C. over a span of 4 weeks. Bituminous mix was prepared following the procedure above and were placed in a 150° C. oven and left over a period of 4 weeks. Sampling of the asphalt-additive mixtures were taken at the end of each week and applied to aggregates to test antistripping performance. The bitumen covered aggregates were subjected to a 24-hour shaking test and visual assessment of the aggregates were made after the completion of shaking bottle test. The results show that the asphalt containing the ELO-SL combination was able to maintain its performance better than the ELO during the storage test. Earlier skinning was also observed with the ELO modified asphalt blend than the ELO-SL blend which may indicate a significantly better thermal stability of the ELO-SL modified asphalt. As shown in Table 2 below, % coating indicated degree of coverage intact on the aggregates. The results highlighted in Table 5 below and FIG. 4 further demonstrate the synergistic impact of the invention composition. The combination of ELO-SL showed stronger resistance to stripping over 4 weeks of thermal aging.

TABLE 5
Amount of aggregate coating post shaking table test measured
after different periods of oven aging over a span of 4 weeks.

| Aging period | 0.50% ELO (BWAA) | 0.50% 50/50 SL/ELO (BWAA) |
|---|---|---|
| Week 0 | 100.00% | 100.00% |
| Week 1 | 46.09% | 75.62% |
| Week 2 | 36.18% | 73.27% |
| Week 3 | 41.98% | 68.88% |
| Week 4 | 40.15% | 51.62% |

BWAA = by weight of additive-aggregate mix

### Example 8—Binder Compatibility with Polyphosphoric Acid (PPA)

The compatibility of a PG64-22 binder modified with ELO, SL, or 50/50 ELO/SL additive was assessed when the binder was also modified with PPA. The resulting blends of the bitumen were tested using a Dynamic Shear Rheometer (DSR) to determine the High Temperature Performance Grade (HTPG) of the asphalt binder blends, following ASTM D7175 (2015). It is believed that PPA increases the HTPG of asphalt binder. However, use of high pH additives such as amine-functional additives can neutralize this impact. Therefore, the compatibility of an additive with PPA can be simply assessed by demonstrating no loss of HTPG (i.e., lower value) after the addition of both additives. The modified asphalt binder blends were prepared by adding 0.5 wt % of the asphalt additive (ELO, SL, and SL/ELO) based on the total weight to the bitumen. The blends were then annealed in a 155° C. forced draft oven for 10 minutes and were mixed with a metal spatula and subsequently poured into 25-mm silicone molds. Samples were cooled down for at least 10 minutes then placed on the DSR to obtain the HTPG at three different temperatures 58° C., 64° C., and 70° C. with a strain of 12% and conditioning of 10 min.

TABLE 6
High Temperature performance grade of binder
modified with different additive combinations

| Sample | HTPG (° C.) |
|---|---|
| Control | 65.06 |
| Binder + 0.5% PPA | 68.51 |
| Binder + 0.5% 50/50-ELO/USL | 64.99 |
| Binder + 0.5% PPA + 0.5% 50/50-ELO/USL | 68.32 |
| Binder + 0.5% 50/50-ELO/USL + 0.5% PPA | 68.25 |

As shown in Table 6, the asphalt containing the ELO-SL combination showed no statistically significant loss in HTPG when both additives were used. Both orders of additions were tried for the two additives, with no impact on the results. The example shows that the additive described in this invention is compatible with asphalt formulations incorporating PPA, significantly improving its utility compared to amine-based additives.

### Example 9—Evaluation of the Impact of Epoxy Oxirane Content (EOC) and Oxirane Distribution on Adhesion Properties

The present technology exhibited synergistic adhesion properties gained from combining phospholipid-containing materials such as lecithin with different epoxidized oils and/or fats, as demonstrated herein. Table 7 shows increasing the % EOC inclusion of epoxidized triacylglycerides (TAG), in this case ESO and ELO blended with lecithin, improved its effectiveness as an adhesion promotor, as measured by % percent coated aggregates after the completion of the shaking bottle test. As demonstrated in Table 7, when the EOC of the epoxidized blend increased, the level of improvement in coating also increased. For this reason, use of epoxidized TAGs with higher potential EOC, such as ELO, improves the adhesion properties of the additives of the present technology.

TABLE 7
PG 64-22 asphalt mixes modified with a warm mix additive blend of
50% Epoxidized oils/fats and 50% SL with dolomite limestones aggregates
containing 53.97% CaCO₃ at varying degrees of EOC.

| | | % Improvement | |
|---|---|---|---|
| | % bitumen coating | in aggregate | |
| | remaining on | coated compared | Additive % |
| Sample | aggregates, % | to control, % | EOC |
| Control | 22.91 | 0.00 | 0 |
| 50/50 ESO/USL | 45.41 | 22.51 | ~3.50 |
| 50/50 ELO/USL | 54.90 | 31.99 | ~4.50 |

### Example 10—Evaluation of the Impact of the Impact of the Epoxidized Oil Structure on Adhesion Properties

Two soy lecithin blends were created using 50% of an epoxidized soy methyl ester (ESME) and compared to the ESO/SL blend of Example 9 in terms of aggregate coating after completion of the shaker table test. The average EOC of ESME and ESO are very similar; however, the oxirane functionality is distributed across a single fatty chain for ESME in contrast to the average of about three fatty chains for ESO. The results shown in Table 8 indicate that the soy lecithin blends in which the same amount of oxirane is distributed across a TAG structure was more effective. Thus, the use of epoxidized methyl esters as the epoxidized renewable oil and/or fat component with lecithin exhibits improved adhesion, but less improved adhesion compared to an epoxidized TAG as the epoxidized renewable oil and/or fat.

TABLE 8
PG 64-22 asphalt mixes modified with a warm mix additive blend of
50% Epoxidized oils/fats and 50% SL with dolomite limestones aggregates
containing 53.97% CaCO₃ at varying degrees of EOC.

| | | Improvement in | |
|---|---|---|---|
| | % bitumen coating | aggregate coated | |
| | remaining on | compared to | Additive % |
| Sample | aggregates, % | control, % | EOC |
| Control | 22.91 | 0.00 | 0 |
| 50/50 ESME/SL | 33.67 | 10.76 | ~3.50 |
| 50/50 ESO/SL | 45.41 | 22.51 | ~3.50 |

Each of the non-limiting aspects above can stand on its own or can be combined in various permutations or combinations with one or more of the other aspects or other subject matter described in this document. While the invention has been illustrated and described in certain aspects, a person with ordinary skill in the art, after reading the foregoing specification can effect changes, substitutions of equivalents and other types of alterations to the present technology as set forth herein. Each aspect described above can also have included or incorporated therewith such variations or aspects as disclosed in regard to any or all of the other aspects.

The present technology is also not to be limited in terms of the particular aspects described herein, which are intended as single illustrations. Many modifications and variations of this present technology can be made without departing from its spirit and scope, as will be apparent to those skilled in the art from the foregoing descriptions. Such modifications and variations are intended to fall within the scope of the appended claims. It is to be understood that this present technology is not limited to particular methods, reagents, compounds, or compositions, which can, of course, vary. It is also to be understood that the terminology used herein is for the purpose of describing particular aspects only and is not intended to be limiting. Thus, it is intended that the specification be considered as exemplary only with the breadth, scope and spirit of the present technology indicated only by the appended claims, definitions therein and any equivalents thereof.

The aspects, illustratively described herein may suitably be practiced in the absence of any element or elements, limitation or limitations, not specifically disclosed herein. Thus, for example, the terms “comprising,” “including,” “containing,” etc. shall be read expansively and without limitations. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the invention. This includes the generic description of the invention with a proviso or negative limitation removing any subject matter form the genus, regardless of whether or not the excised material is specifically.

1. An asphalt additive comprising:
a phospholipid material; and
an epoxidized renewable oil or fat, wherein the epoxidized renewable oil or fat has an oxirane content of about 1.0% to about 15.0%.

2. The asphalt additive of claim 1, wherein the asphalt additive comprises a weight ratio of the phospholipid material to the epoxidized renewable oil or fat of about 5:1 to about 1:5.

3-4. (canceled)

5. The asphalt additive of claim 1, wherein the asphalt additive comprises a weight ratio of the phospholipid material to the epoxidized renewable oil or fat of about 1:1.

6. The asphalt additive of claim 1, wherein the asphalt additive comprises about 10.0 weight percent (wt %) to about 80.0 wt % of the phospholipid material based on total weight of the asphalt additive.

7. (canceled)

8. The asphalt additive of claim 1, wherein the phospholipid material comprises at least about 50 wt % to 100 wt % of phospholipids based on total weight of the phospholipid material.

9-12. (canceled)

13. The asphalt additive of claim 1, wherein the phospholipid material comprises a lecithin material, wherein the lecithin material comprises soybean lecithin, rapeseed lecithin, sunflower-seed lecithin, egg lecithin, peanut lecithin, corn lecithin, bovine brain lecithin, jojoba lecithin, or mixtures thereof.

14-15. (canceled)

16. The asphalt additive of claim 1, wherein the additive comprises about 10.0 wt % to about 80.0 wt % of the epoxidized renewable oil or fat based on total weight of the asphalt additive.

17-21. (canceled)

22. The asphalt additive of claim 1, wherein the epoxidized renewable oil or fat comprises epoxidized soybean oil, epoxidized canola oil, epoxidized linseed oil, epoxidized soy methyl ester, epoxidized linseed methyl ester, epoxidized tall oil fatty acid (TOFA), epoxidized acetylated-triacylglycerol, epoxidized acetylated-diacylglycerol, epoxidized acetylated-monoacylglycerol, epoxidized jojoba oil, epoxidized 2-ethylhexyl soyate, epoxidized 2-ethylhexyl TOFA, epoxidized isoamyl soyate, epoxidized isoamyl palm stearin, epoxidized isoamyl TOFA, epoxidized isoamyl soyate, epoxidized soy methyl ester acetic acid estolide, or mixtures thereof.

23-26. (canceled)

27. The asphalt additive of claim 1 further comprising a fatty acid material, wherein the fatty acid material comprises soybean oil, linseed oil, canola oil, or mixtures thereof.

28. The asphalt additive of claim 27, wherein the additive comprises about 0.1 wt % to about 40 wt % of the fatty acid material based on total weight of the additive.

29-30. (canceled)

31. The asphalt additive of claim 1, wherein the additive has a viscosity of about 20 cSt to about 10,000 cSt at 25° C.

32. The asphalt additive of claim 1, wherein the asphalt additive is a warm mix asphalt additive or a hot mix asphalt additive.

33. (canceled)

34. The asphalt additive of claim 1, wherein the asphalt additive enhances one or more performance properties in asphalt applications comprising adhesion, compaction, durability, antistripping, or combinations thereof.

35-38. (canceled)

39. An asphalt binder comprising:
bitumen; and
an asphalt additive comprising a phospholipid material and an epoxidized renewable oil or fat, wherein the epoxidized renewable oil or fat has an oxirane content of about 1.0% to about 15.0%.

40. (canceled)

41. The asphalt binder of claim 39, wherein the asphalt binder comprises about 0.1 wt % to about 3.0 wt % of the asphalt additive based on total weight of the asphalt binder, and wherein the asphalt binder comprises about 97.0 wt % to about 969.9 wt % of bitumen based on total weight of the asphalt binder.

42-46. (canceled)

47. An asphalt concrete comprising:
about 0.25 wt % to about 8.0 wt % of an asphalt binder, based on total weight of the asphalt concrete, comprising:
bitumen; and
an asphalt additive comprising a phospholipid material and an epoxidized renewable oil or fat having an oxirane content of about 1.0% to about 15.0%; and
mineral aggregate based on total weight of the asphalt concrete.

48. The asphalt concrete of claim 47, wherein the asphalt concrete comprises about 92.0 wt % to about 99.75 wt % of the mineral aggregate.

49. A method of preparing a stable asphalt additive blend, the method comprising:
combining a phospholipid material with an epoxidized renewable oil or fat having an oxirane content of about 1.0% to about 15.0%; and
mixing the phospholipid material and the epoxidized renewable oil or fat under high shear to obtain the asphalt additive blend.

50-52. (canceled)

53. A method of preparing an asphalt binder comprising:
combining bitumen with an asphalt additive, wherein the asphalt additive comprises a phospholipid material and an epoxidized renewable oil or fat having an oxirane content of about 1.0% to about 15.0%.

54-55. (canceled)

56. A method for reducing or preventing stripping, promoting adhesion, aiding compaction, and/or improving durability of asphalt concrete comprising:
combining an asphalt additive comprising a phospholipid material and an epoxidized renewable oil or fat to bitumen to obtain an asphalt binder, and
combining the asphalt binder to mineral aggregates to obtain an asphalt concrete;
wherein the asphalt concrete comprises about 0.25 wt % to about 8.0 wt % of the asphalt binder.
